(19) United States
(12) Patent Application Publication
(10) Pub. No.: US 2022/0358587 A1
(43) Pub. Date: Nov. 10, 2022

(54) ASSET TRADING SYSTEM, METHOD, AND STORAGE MEDIUM

(71) Applicant: WINTRADO TECHNOLOGIE AG, Luzen (CH)

(72) Inventors: Roland Scholler, Binz (CH); Pascal Ehlert, Munchen (DE); Robin Strang, Meschede (DE)

(21) Appl. No.: 17/622,093

(22) PCT Filed: Jun. 10, 2020
(86) PCT No.: PCT/EP2020/066075

§ 371 Date: Dec. 22, 2021

(30) Foreign Application Priority Data
Jun. 27, 2019 (IE) S2019/0106

(51) Int. Cl. G06Q 40/04; G06T 11/20

(52) U.S. Cl. CPC G06Q 40/04; G06T 11/206

(57) ABSTRACT

Given a data processing system (100) for trading assets comprising a trading application (102) and a trading platform (104) comprising at least one server (105), it is an objective of the invention to improve the user interaction with the trading application. The objective is solved by the system configured to perform the steps: a) sending a signal from the trading application (102) to the trading platform (104), the signal indicating a request to enter the position, the request indicating the asset; b) storing in a database of the server (105) at least an identification of the asset and an identification of a position size, a user, and a timestamp indicating a time of purchase; c) forwarding market prices of the asset to the trading application (102); d) calculating a position value at a current time based on the market prices, the position size, and a holding fee, wherein the holding fee is based on a holding time derived from a duration since the time of purchase to the current time; and e) displaying the position value in the trading application (102).

The invention relates to a system for trading assets.

Buying and selling assets on a trading exchange has traditionally been done through brokers on trading floors. Increasingly, investors can trade via internet accessed brokerage firms. With the increased mobility of investors, orders may be put using an application in a mobile device. However, user interfaces in the trading applications are limited. The information provided on applications is difficult to understand, and the fees levied unclear. The number of fields that must be entered is an obstacle to placing an order. This is burdensome, in particular for less experienced investors and consumers.

The deficiency is solved by the system of claim 1, the method of claim 14, and the storage medium of claim 15.

In particular, the deficiency is solved by a data processing system for trading assets, the system comprising:
a trading application; and
a trading platform comprising at least one server;

the system configured to perform the steps:
a) sending a signal from the trading application to the trading platform, the signal indicating a request to enter a position, the request indicating an asset;
b) storing in a database of the server at least an identification of the asset and an identification of a position size, a user, and a timestamp indicating a time of purchase;
c) forwarding market prices of the asset to the trading application;
d) calculating a position value at a current time based on the market prices, the position size, and a holding fee, wherein the holding fee is based on a holding time derived from a duration since the time of purchase to the current time; and
e) displaying the position value in the trading application.

The advantages include an improved man-machine interface substantially facilitating trading, in particular within a hand-held mobile device, and in particular for less experienced traders. The advantages include that a position may be entered by only entering a desired asset and an amount to be spent. Optionally, a confirm button may be clicked. The amount may be deducted from a current balance for a user of the trading application. The current balance may be stored in the trading platform and displayed to the user on the trading application. The trading application might always show the position value that will be added to the user's current balance if the user exits the position (e.g. sells an asset). This substantially facilitate the understanding of the value and fees. Holding fees are levied based on the duration of holding the position, and position value is updated accordingly, substantially facilitating the understanding of the fees. When the position is closed, the position value might intuitively be added to the current balance.

Displaying the position in step e) may include providing the position value with a first indication, such as providing a green colour to the position value, if the position value is above the initial cost of entering the position. Displaying the position in step e) may include providing the position value with a second indication, such as providing a red colour to the position value, if the position value is above the initial cost of entering the position.

The market prices may be bid prices, stating a price for which a third party is willing to buy the asset. A market maker may also (manually or automatically) generate market prices. A trading exchange may receive, store, and distribute market prices, such as bid prices and ask prices. The trading exchange may also be utilized for selling and buying assets. The trading application may include a trading exchange or be a separate entity. The trading application may also communicate with a trading exchange.

Forwarding market prices to the trading application may be done by the trading platform from a trading exchange in a push manner. The trading application may also request market prices from the trading exchange or the trading platform in a pull manner.

The position value may be displayed on a display of the trading application.

A position may be any suitable position, such as entering a long or a short position on any suitable underlying asset. The asset may be any suitable asset that is identifiable and traded. The asset may be based on equities (stocks), fixed income (bonds), currency (including cryptocurrencies), commodities, etc. The position may relate to funds, such as an index or exchange-traded funds, that may be open-ended or closed-ended. The position may be based on derivative of the asset, and may include forward, futures, options etc. The position may be leveraged or unleveraged. Entering a position means entering a contract to the effect of owning or owing a security or other asset. Exiting a position means selling or returning the asset. The entering of a position may be implemented by closing an order with a third party directly or via an exchange. The entering of a position may also be stored in the server of the trading platform, e.g. by entering a record in a data list.

The holding fee is a fee that is levied based on the duration of the time of holding a position. The holding fee is typically levied from the user of the trading application.

The request to enter a position may be a market order, preferably indicating an amount (preferably in a pre-defined currency, such as in the currency in which the asset is traded) for which the asset should be bought or the position should be entered. The request may alternatively include a number of an asset to be bought or sold. The request may also be a limit order or a stop order. The position size stored in the database relates to the number of the asset for which the position is entered.

The one embodiment, the holding fee is based on a quotient (q) of dividing the holding time (T) with a pre-determined time interval (I):

$$q = ⌊ \frac{T}{I} ⌋$$

leading to an increase in the holding fee occurring with the interval (I); and wherein the time interval (I) is stored preferably in the trading platform and communicated to the trading application.

In one embodiment, the system further comprises a storage of a current balance for the user,

and the system is further configured to:
a1) in response to step a), reducing the current balance with a position cost,

wherein the position cost is preferably based on a purchase price of the asset.

In one embodiment, the system is further configured to:
f) sending a signal from the trading application to the trading platform, the signal indicating a request to exit the position;
g) based on the position value of the asset, adding a sell amount to a/the current balance; and
h) closing the position in the trading platform.

In one embodiment, the system is further configured to:
f1) in response to receiving the request of step f), sending a signal to a trading exchange with an order to sell the asset and/or a derivative thereof.

In one embodiment, the system is further configured to:
a2) after receiving the signal indicating the request to enter the position, blocking the request if a/the current balance and/or a credit are below a purchase amount required to enter the position.

In one embodiment, the system is further configured to:
a3) in response to receiving the request of step a), sending a signal to a trading exchange with an order to buy the asset and/or a derivative thereof.

In one embodiment, the system is further configured to:
e1) in response to the current balance reaching at or below zero, exit the position and/or removing the position from the trading application.

Advantages include that the position value is prevented from being negative, i.e. the user owing more money than invested. The embodiment may be similar to a stop-loss order but include the decrease of the position value due to the recurring holding fee. The embodiment may be implemented by a traditional stop-loss order that is initially set to zero, and is updated and increases at each time interval (I) with a recurring holding fee divided by the position size.

In one embodiment, the system is further configured to:
e2) displaying a visualization of the remaining time until an increase in the holding fee;

wherein the remaining time is calculated based on a remainder (r) of dividing the holding time (T) with the pre-determined time interval (I):

r=rem(T,I).

Visualizing the remaining time until the next holding fee deduction on the trading application facilitates for the understand of when and how much holding fees are levied. The pre-determined time interval may be stored in the trading platform and may be dependent on factors such as the asset type, user contract, etc. The holding fee interval may be communicated to the trading application. The remaining time may be calculated within the trading application and updated frequently.

Typically the update interval of the remaining time is much shorter than the holding fee interval. This allows the user to take action before the next holding fee is levied. Before the remaining time reaches the next holding fee deduction time, the holding time of the trading application may be synchronized with a holding time on the trading platform, which may hold the master holding time.

The position value may be updated in the trading platform and sent to trading application from the trading platform. The trading platform may hold the master position value. When a position is closed (e.g. an asset sold), the current position value may be added to the current balance in the trading platform, before the current balance is communicated to, and updated in, the trading application. This improves integrity of the system.

In one embodiment, an update interval of the visualization of step e2) is shorter than the pre-determined time interval (I), in particular at least 5 or 10 times shorter; and

wherein update of the visualization in step e2) is performed by the trading application.

In one embodiment, displaying in step e) allows the remaining time (r) as a fraction of the pre-determined time interval (I) to be determined.

In one embodiment, the fraction is visualized as a progress bar and/or as a doughnut chart.

In one embodiment, the position value is displayed in the middle of the/a doughnut chart.

The deficiency is further addressed with a computer-implemented method for trading assets, the method preferably implemented by the system described herein, the method comprising the steps:
a) sending a signal from a trading application to a trading platform, the signal indicating a request to enter a position, the request indicating an asset;
b) storing in a database of a server at least an identification of the asset and an identification of a position size, a user, and a timestamp indicating a time of purchase;
c) forwarding market prices of the asset to the trading application;
d) calculating a position value at a current time based on the market prices, the position size, and a holding fee, wherein the holding fee is based on a holding time derived from a duration since the time of purchase to the current time; and
e) displaying the position value in the trading application.

The deficiency is further addressed with a Computer-readable medium comprising instructions which, when executed by a data processing system, such as the herein described system, cause the system to carry out the steps of the herein described method.

The benefits and advantages of the method and the storage medium are equal, or similar to, the advantages of the above-mentioned system.

In the following, embodiments of the invention are described with respect to the figures, wherein

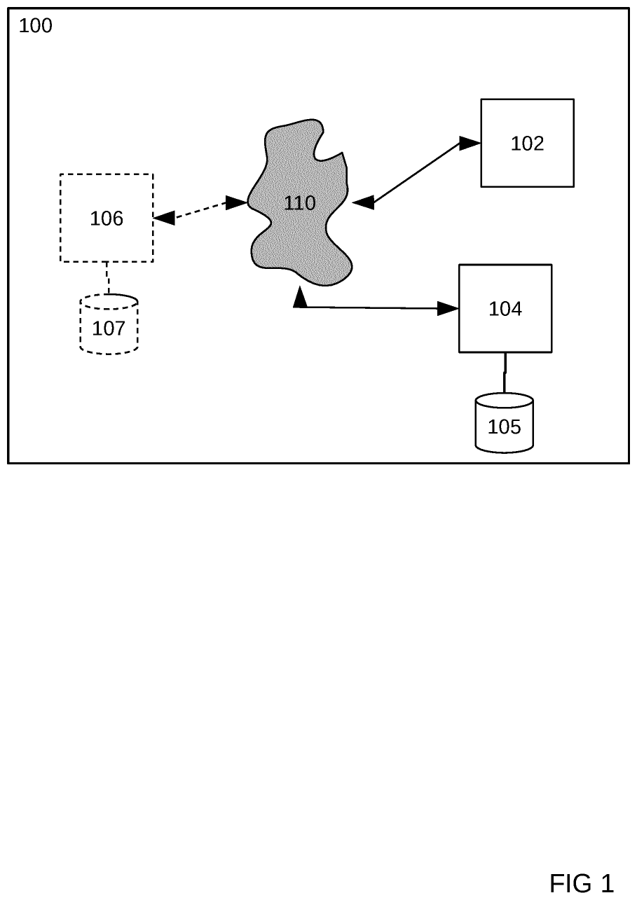

FIG. 1 shows a system for trading assets;

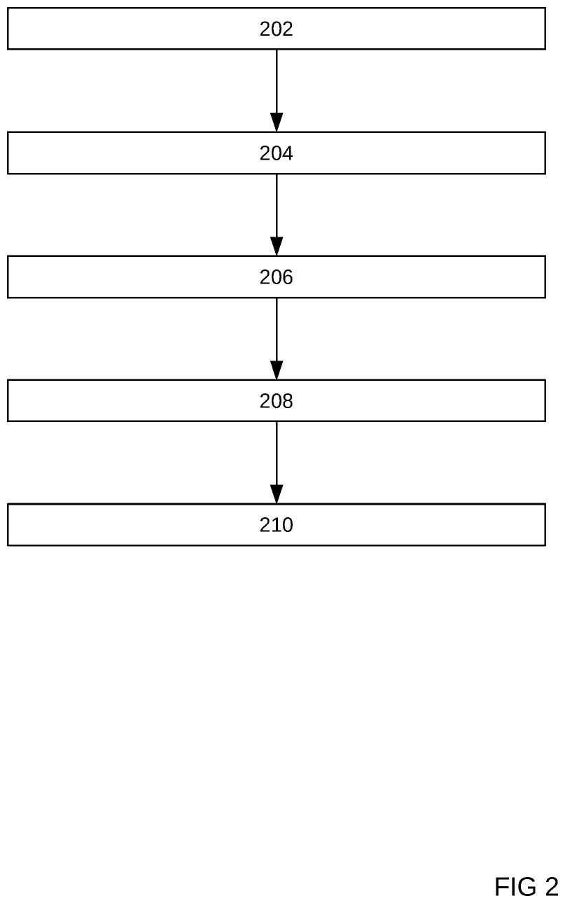

FIG. 2 shows a method for trading assets;

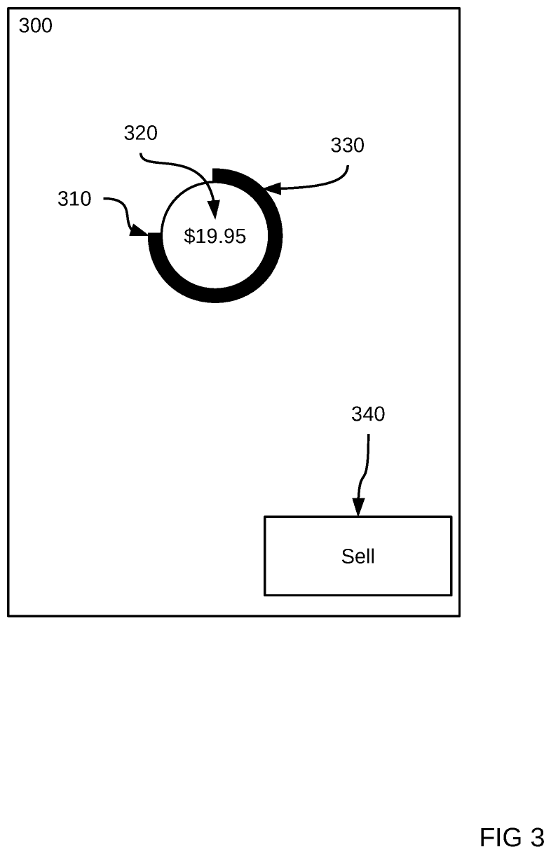

FIG. 3 shows a display of a trading application.

FIG. 1 shows a system 100 for trading assets, the system comprising a trading application 102 and a trading platform 104 comprising at least one server 105. The system also comprises a means for communication 110 between the trading application 102 and the trading platform 104. The system may further communicate with a trading exchange to put orders on buying and/or selling assets and/or to receive market prices.

FIG. 2 shows steps for trading assets on a trading exchange, including a) sending 202 a signal from a trading application 102 to a trading platform 104, the signal indicating a request to enter a position, the request indicating an asset; b) storing 204 in a database of a server 105 at least an identification of the asset and an identification of a position size, a user, and a timestamp indicating a time of purchase; c) forwarding 206 market prices of the asset to the trading application 102; d) calculating 208 a position value at a current time based on the market prices, the position size, and a holding fee, wherein the holding fee is based on a holding time derived from a duration since the time of purchase to the current time; and e) displaying 210 the position value in the trading application 102.

FIG. 3 shows a display 300 of a trading application including a visualization 310 of the remaining time until the next increase in the holding fee. The remaining time as a fraction 310 of the time interval between holding fee increases may be visualized as a doughnut chart 330. The position value 320 may be displayed in the middle of the doughnut chart.

The trading application may include functionality to exit an entered position. This may be done by clicking a “sell” button 340. When clicking the sell button, the position may be closed and the residue added to the current balance.

As an example, the trading platform may communicate with a trading exchange to put orders and receive market prices. The trading platform may also communicate with one or more brokers, such as one or more broker servers for some or all of the functionality that alternatively may be carried out by communicating directly with the trading exchange.

### LIST OF REFERENCE NUMERALS

100 system for trading assets;
110 means for communication;
102 trading application;
104 trading platform;
105 server of trading platform;
106 trading exchange;
107 server of trading exchange;
202 sending a signal from a trading application to a trading platform;
204 storing in a database of a server;
206 forwarding market prices;
208 calculating a position value;
210 displaying the position value;
300 display;
310 visualization of the remaining time;
320 position value;
330 doughnut chart;
340 sell button;

1. A data processing system (100) for trading assets, the system comprising:
a trading application (102); and
a trading platform (104) comprising at least one server (105);
the system configured to perform the steps:
a) sending a signal from the trading application (102) to the trading platform (104), the signal indicating a request to enter a position, the request indicating an asset;
b) storing in a database of the server (105) at least an identification of the asset and an identification of a position size, a user, and a timestamp indicating a time of purchase;
c) forwarding market prices of the asset to the trading application (102);
d) calculating a position value at a current time based at least on the market prices, the position size, and a holding fee, wherein the holding fee is based on a holding time derived from a duration since the time of purchase to the current time; and
e) displaying the position value in the trading application (102).

2. The system of claim 1, wherein the holding fee is based on a quotient (q) of dividing the holding time (T) with a pre-determined time interval (I):
q=└T/I┘
leading to an increase in the holding fee occurring with the interval (I); and
wherein the time interval (I) is stored preferably in the trading platform (104) and communicated to the trading application (102).

3. The system of claim 1, wherein the system further comprises a storage of a current balance for the user,
and the system is further configured to:
a1) in response to step a), reducing the current balance with a position cost, wherein the position cost is preferably based on a purchase price of the asset.

4. The system of claim 1, wherein the system is further configured to:
f) sending a signal from the trading application (102) to the trading platform (104), the signal indicating a request to exit the position;
g) based on the position value of the asset, adding a sell amount to a/the current balance; and
h) closing the position in the trading platform (104).

5. The system of claim 4, wherein the system is further configured to:
f1) in response to receiving the request of step f), sending a signal to a trading exchange (106) with an order to sell the asset and/or a derivative thereof.

6. The system of claim 1,
wherein the system is further configured to:
a2) after receiving the signal indicating the request to enter the position, blocking the request if a/the current balance and/or a credit are below a purchase amount required to enter the position.

7. The system of claim 1,
wherein the system is further configured to:
a3) in response to receiving the request of step a), sending a signal to a trading exchange (106) with an order to buy the asset and/or a derivative thereof.

8. The system of claim 1,
wherein the system is further configured to:
e1) in response to the current balance reaching at or below zero, exit the position and/or remove the position from the trading application (102).

9. The system of claim 1, wherein the system is further configured to:
e2) displaying a visualization (310) of the remaining time until an increase in the holding fee;
wherein the remaining time is calculated based on a remainder (r) of dividing the holding time (T) with the pre-determined time interval (I):
r=rem(T,I).

10. The system of any of the claim 9, wherein an update interval of the visualization of step e2) is shorter than the pre-determined time interval (I), in particular at least 5 or 10 times shorter; and
wherein update of the visualization in step e2) is performed by the trading application (102).

11. The system of claim 9, wherein displaying in step e2) allows the remaining time (r) as a fraction of the pre-determined time interval (I) to be determined.

12. The system of claim 11, wherein the fraction is visualized as a progress bar and/or as a doughnut chart (330).

13. The system of claim 12, wherein the position value (320) is displayed in the middle of the/a doughnut chart.

14. A computer-implemented method for trading assets, the method preferably implemented by the system of any of the previous claims, the method comprising the steps:
a) sending a signal from a trading application (102) to a trading platform (104), the signal indicating a request to enter a position, the request indicating an asset;
b) storing in a database of a server (105) at least an identification of the asset and an identification of a position size, a user, and a timestamp indicating a time of purchase;
c) forwarding market prices of the asset to the trading application (102);
d) calculating a position value at a current time based at least on the market prices, the position size, and a holding fee, wherein the holding fee is based on a holding time derived from a duration since the time of purchase to the current time; and
e) displaying the position value in the trading application (102).

15. A Computer-readable medium comprising instructions which, when executed by a data processing system, cause the system to carry out the steps of claim 14.
